(19) United States
(12) Patent Application Publication
(10) Pub. No.: US 2012/0013933 A1
(43) Pub. Date: Jan. 19, 2012

(54) METHOD FOR OPERATING PRINTING PROCESS

(75) Inventors: Tony TSENG, Taipei City (TW); Johnny Hsiang-yu Chen, Santa Ana, CA (US)

(73) Assignee: I/O Interconnect, Ltd.

(21) Appl. No.: 13/244,278

(22) Filed: Sep. 24, 2011

Related U.S. Application Data
(63) Continuation-in-part of application No. 12/754,829, filed on Apr. 6, 2010.

(51) Int. Cl. G06K 15/02

(52) U.S. Cl. 358/1.13; 358/1.15

(57) ABSTRACT

A method for operating a printing process on a printer is disclosed. The method includes the steps of: a) installing a software application into a computer; b) operating a printer connected to the computer to browse files thereof through the software application; c) selecting a file to be printed; d) placing a printing command for the file from the printer to the computer; and e) executing a printing task from the computer to the printer.

### CROSS-REFERENCE TO RELATED APPLICATIONS

This is a continuation-in-part of U.S. patent application Ser. No. 12/754,829, filed Apr. 6, 2010.

### BACKGROUND OF THE INVENTION

1. Technical Field

The invention relates to printers, particularly to printing management and operation.

2. Related Art

It is common that a computer peripheral device possesses a control means and a display device to facilitate local operations for users. For example, prior art printers are generally equipped with a display device and operation keys to provide a user interface for users to turn on/off or select an operation mode. In fact, a printer is an output device which only accepts commands from a computer. A user must operate a computer to start a print task including a file to be printed and printing conditions.

In some cases, however, a computer is not adjacent to a printer connected thereto. There may be a situation in practice: a user has arrived at the location of a printer to take the printed document after he or she sends out a print task from a computer, but suddenly he or she wants one more copy of the printed document. Under this situation, the user must go back to the computer and then resends a new print task. Of course, it is necessary to go to the printer again to take the accessional copy. This is very inconvenient for users. The reason why this inconvenience appears is that conventional printers do not allow users to operate and send out a print task on itself.

### SUMMARY OF THE INVENTION

An objective of the present invention is to provide a method for operating a printing process, which allows a user to start a print task on a printer for a file stored in a computer.

To accomplish the foregoing objective, the method of the present invention includes the steps of: a) installing a software application into a computer; b) operating a printer connected to the computer to browse files thereof through the software application; c) selecting a file to be printed; d) placing a printing command about the file from the printer to the computer; and e) executing a printing task from the computer to the printer.

### BRIEF DESCRIPTION OF THE DRAWINGS

FIG. 1 is a block diagram of a computer and a printer of the present invention; and

FIG. 2 is a flowchart of the present invention.

### DETAILED DESCRIPTION OF THE INVENTION

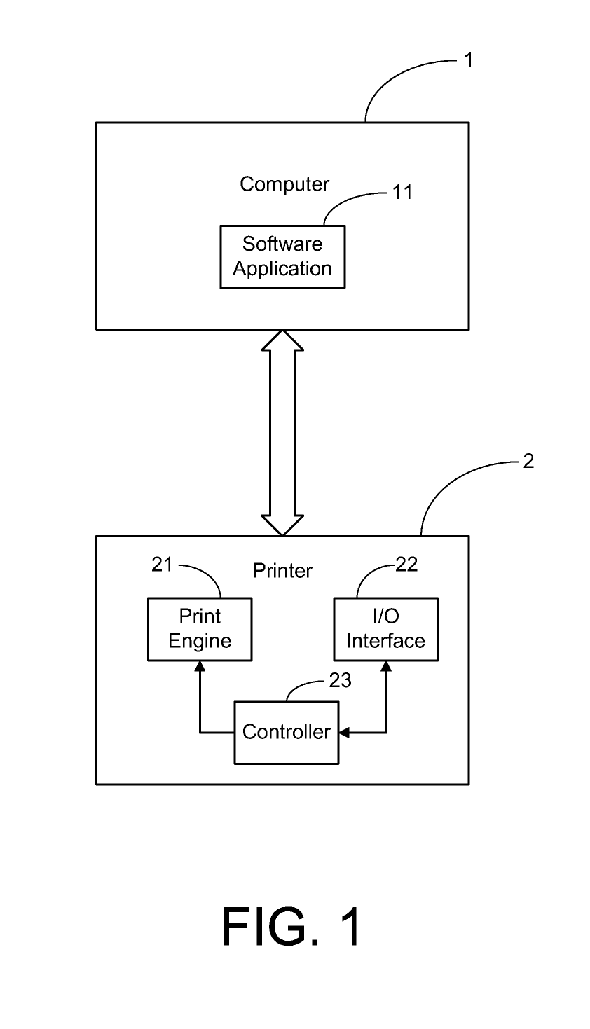

Please refer to FIG. 1. A printer 2 is coupled to a computer 1 through a wired or wireless connection such as a USB (universal serial bus) cord, Wi-Fi or Bluetooth protocol. The printer 2 includes a print engine 21, an input/output (I/O) interface 22 and a controller 23. The computer 1 is installed with a software application 11 based on an operating system (OS) thereof. The software application 11 corresponds to the controller 23 of the printer 2 to cooperate with each other. The controller 23 may be an additional piece which is independent from an inherent primary controller or functionally merged with the primary controller. The I/O interface 22 includes keys and a display for inputting data and showing information. The I/O interface 22 can associate with the software application 11 through the controller 23.

In a normal operation mode, a user operates the computer 1 to execute a printing task including a print command and the data of the file to be printed. The print command further includes print conditions such as the number of copy, size, resolution, etc. Every printer including the present invention can work in this mode.

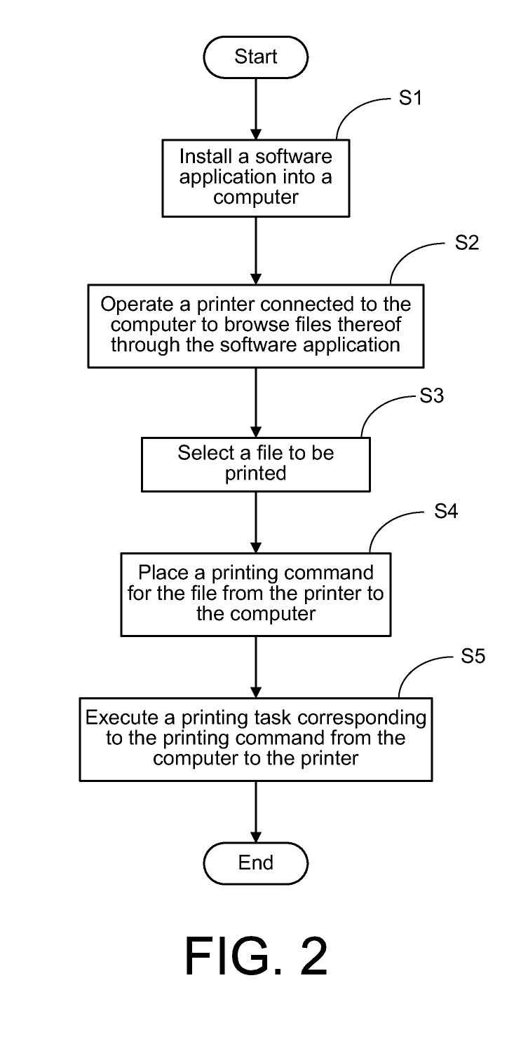

The present invention provides another mode for users, which is believed more convenient than ever. Please refer to FIG. 2, which shows a flowchart of the present invention. In step S1, the method requires to install the software application 11 in the computer 1 first. The software application 11 is capable of providing the file system of the computer 1 to the controller 23 of the printer 2 so that the file system will be operatably displayed on the I/O interface 22 of the printer 2. As a result, users can see and operate the file system of the computer 1. Thus, in step S2, a user operates the I/O interface 22 of the printer 2 to browse the file system of the computer 1. Next, the user selects a file to be printed in step S3.

After the file to be printed has been selected, the user places a printing command for the file from the printer 2 to the computer 1 in step S4. The printing command includes a path of the file and printing conditions such as the number of copy, size, resolution, etc. After that, the software application 11 will receive the printing command and interact with the operating system of the computer 1. Finally, the computer 1 executes a printing task corresponding to the printing command from the computer 1 to the printer 2 in step S5. The step S5 is just like the abovementioned normal operation mode.

When the method of the present invention is applied, users can start a printing procedure on a printer without being limited on a computer. This is very convenient for users, especially in those circumstances which place a computer apart from a printer.

While the invention has been described by way of an example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for operating a printing process, comprising the steps of:
a) installing a software application into a computer;
b) operating a printer connected to the computer to browse files thereof through the software application;
c) selecting a file to be printed;
d) placing a printing command for the file from the printer to the computer; and
e) executing a printing task corresponding to the printing command from the computer to the printer.

2. The method of claim 1, wherein the printer comprises a print engine, an input/output (I/O) interface and a controller, the I/O interface further comprises keys and a display, and the I/O interface is capable of associating with the software application through the controller.

3. The method of claim 1, wherein the software application is capable of providing a file system of the computer to the controller of the printer so that the file system is operatably displayed on the I/O interface of the printer.

4. The method of claim 1, wherein the printing command comprises a path of the file and printing conditions.
